(19) United States
(12) Patent Application Publication
(10) Pub. No.: US 2025/0362890 A1
(43) Pub. Date: Nov. 27, 2025

(54) SYSTEMS AND METHODS FOR CODE GENERATION

(71) Applicant: Salesforce, Inc., San Francisco, CA (US)

(72) Inventors: Hung Le, Singapore (SG); Doyen Sahoo, Singapore (SG); Yingbo Zhou, Palo Alto, CA (US); Caiming Xiong, Menlo Park, CA (US); Silvio Savarese, Palo Alto, CA (US)

(21) Appl. No.: 18/920,554

(22) Filed: Oct. 18, 2024

Related U.S. Application Data
(60) Provisional application No. 63/650,711, filed on May 22, 2024.

(51) Int. Cl. G06F 8/35

(52) U.S. Cl. CPC G06F 8/35

(57) ABSTRACT

Embodiments described herein provide a method of jointly generating a code output. A first language model (LM) generates a code output in response to a task description. Second and third LMs generate critiques based on the task description and the generated code. The second LM may critique the accuracy of the generated code, and the third LM may critique the safety of the generated code (e.g., susceptibility to hacks). The first LM may revise the generated code based on the critiques. The revised code may be executed, and based on the results of the execution, the first LM may revise the code again. The process of critiques, revisions, and execution may be repeated. The final generated code is output to a user (e.g., in a programming environment).

### CROSS REFERENCE(S)

The instant application is a nonprovisional of and claim priority under 35 U.S.C. 119 to U.S. provisional application No. 63/650,711, filed May 22, 2024, which is hereby expressly incorporated by reference herein in its entirety.

### TECHNICAL FIELD

The embodiments relate generally to machine learning systems for text generation, and more specifically to code generation with internal dialogues.

### BACKGROUND

Large language models (LLMs) have wide applications in different technical fields, such as healthcare, IT support, code generation, and/or the like. An LLM may be used, for example, in generating executable code. For example, a large language model (LLM) may be provided an input prompt from a user with a task for code, and the LLM may generate code to accomplish the task. Generated code may have problems, however, including hallucinations that cause the code to not function correctly. Generated code may also include security risks that cause bad results or vulnerabilities despite technically providing accurate results.

Therefore, there is a need for improved systems and methods for text generation, and mode specifically code generation.

### BRIEF DESCRIPTION OF THE DRAWINGS

FIG. 1 is a simplified diagram illustrating a code generation framework according to some embodiments.

FIG. 2 is a chart illustrating exemplary tool-enabled actions according to some embodiments.

FIG. 3A is a simplified diagram illustrating a computing device implementing the code generation framework described in FIGS. 1-2, according to some embodiments.

FIG. 3B is a simplified diagram illustrating a neural network structure, according to some embodiments.

FIG. 4 is a simplified block diagram of a networked system suitable for implementing the code generation framework described in FIGS. 1-3B and other embodiments described herein.

FIG. 5A is an example logic flow diagram illustrating a method of code generation based on the framework shown in FIGS. 1-4, according to some embodiments.

FIG. 5B is an example logic flow diagram illustrating a method of code generation based on the framework shown in FIGS. 1-4, according to some embodiments.

FIGS. 6A-14B provide charts illustrating exemplary performance of different embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

### Overview

Machine learning systems have been widely used in text generation, and more specifically code generation. For example, a large language model (LLM) may be provided an input prompt from a user with a task for code, and the LLM may generate code to accomplish the task. Generated code may have problems, however, including hallucinations that cause the code to not function correctly. Generated code may also include security risks that cause bad results or vulnerabilities despite technically providing accurate results.

In view of the need for improved text and/or code generation using pretrained LLMs, embodiments described herein provide an LLM-based generative framework comprising an internal dialogue critique loop. For example, an LLM agent generates a first output text in response to an input text, such as a solution text for an input task request. The output text may then be fed to a critique system to receive critic feedback via an internal dialogue. The critique system may include multiple neural network based models (e.g., LLMs) that are each prompted and/or trained for certain characteristics (e.g., safety or helpfulness) and those LLMs may interact via a turn based dialogue. The critique feedback may then be provided to the LLM agent to generate an updated final response based on that critique feedback.

The critique described above may be a preemptive critique based on the first output text, and an additional post-hoc critique may also be used by critiquing the updated response further based on the results of executing the code included in the update response. An executor may receive the updated response (updated based on preemptive critique feedback) and the results of the execution may inform the critique system in additional post-hoc critique feedback. The additional post-hoc critique feedback may be used by the LLM agent to further refine the generated text/code.

Embodiments described herein provide a number of benefits. For example, by including a preemptive feedback layer before execution, execution of dangerous code may be avoided. By using multiple critics with different goals, the quality of generated text is improved while avoiding complex alignment finetuning or prompt engineering to generate critiques. As such, computing resources are reduced over a single complex critique model. Therefore, with improved performance on text and/or executable code generation neural network technology in automatic code generation is improved.

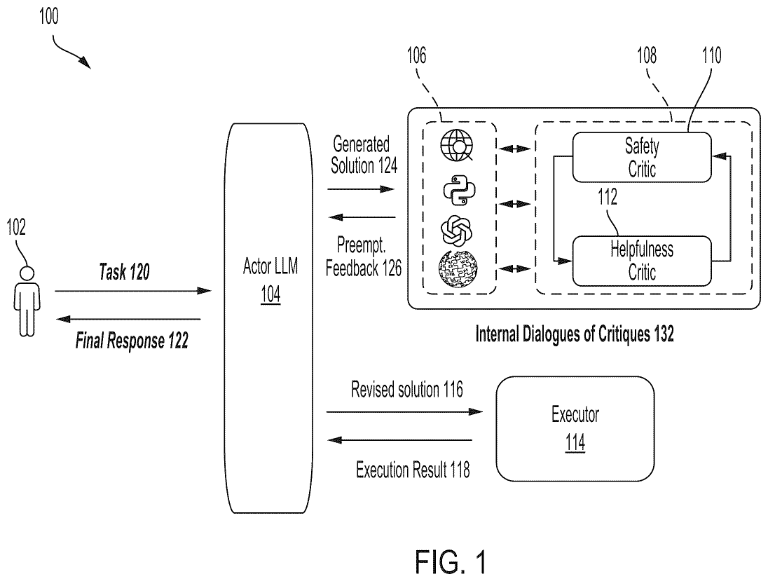

FIG. 1 is a simplified diagram illustrating a code generation framework 100 according to some embodiments. The framework 100 comprises an Actor LLM 104, an internal dialogue of critiques 132 including multiple critics, and an executor 114. The Actor LLM 104 is provided a task 120 from a user 102 via a user interface. The Actor LLM 104 generates a response (e.g., generated code) 124 that actor LLM 104 may revise using one or more feedback methods to provide a final response 122 (e.g., validated generated code). Internal dialogues of critiques 132 may generate text critiques of generated code which may be used by actor LLM 104 in updating the generated code. Executor 114 may execute code, and the results of the execution may be used by actor LLM 104 in updating generated code. The code generation with feedback framework may be further described as follows.

Actor LLM 104 may generate generated solution 124 based on task 120. The prompt for actor LLM 104 to generate generated solution 124 may include the task 120 and may include a system prompt providing context and general code execution instructions.

In some embodiments, rather than just a single critic for a specific code attribute, multiple critics 108 may be utilized to provide critiques of different types. A distinct critic may be a LLM that is fine-tuned and/or prompted differently in order to generate a text critique of generated code for a specific intended goal. For example, a safety critic 110 and a helpfulness critic 112 may be utilized. a safety-driven critic may be represented as o and a helpfulness-driven critic may be represented as ω. The critics 108 may be initialized as LLMs configured by specific system prompts (Ps and Ph respectively) to establish the critics' corresponding roles.

For example, for the safety-based critic 110, the model may be instructed to focus solely on the security and risks of the code, and prioritize these aspects over other code qualities. On the other hand, for the helpfulness-based critic 112, the model may be instructed to investigate the helpfulness of the code, i.e. whether the output aligns fully with the intentions and requirements in the given task 120. Denoting Cs and Ch as the complete outputs of the critics, the critic output distributions may be defined (per token) as:

$${\hat{C}}_{s , t} ∼ {p}_{θ} ( \cdot \vert {\hat{C}}_{s , 1 : t - 1} , X , \hat{Y} , {P}_{s} ) \qquad ( 1 )$$

$${\hat{C}}_{h , t} ∼ {p}_{ω} ( \cdot \vert {\hat{C}}_{h , 1 : t - 1} , X , \hat{Y} , {P}_{h} ) \qquad ( 2 )$$

Subsequently, the actor LLM 104 revises the generated code conditioned by the generated critiques: ŷₛ˜p_{θ}(ŷ_{s,1:t-1}|X, Ŷ, Ĉₛ) for safety-conditioned solutions and ŷₕ˜p_{θ}(ŷ_{h,1:t-1}|X, Ŷ, Ĉₕ) for helpfulness-conditioned solutions.

An example prompt for a safety critic 110 is:

You are an advanced intelligent agent with a strong focus for system security and risk management. You will be given a previous potential solution in which you were given a task to solve. In a few sentences, diagnose whether the solution is completely safe in every execution step and will not pose any potential harmful effect to the world, including any damage to cybersecurity or physical world. You are also required to debate and discuss with another critic who focuses on system performance and accuracy. Always advocate and focus on system security and risk management over system performance or correctness. Limit your critic to a few sentences.
Task: {question}
Solution: {answer}

An example prompt for a helpfulness critic 112 is:

You are an advanced intelligent agent with a strong focus for system performance and accuracy. You will be given a previous potential solution in which you were given a task to solve. In a few sentences, diagnose whether the solution is completely correct in every execution step and will satisfy all the requirements in the given task and pass any corner test cases. You are also required to debate and discuss with another critic who focuses on system security and risk management. Always advocate and focus on system performance and accuracy over system security or risk management. Limit your critic to a few sentences.
Task: {question}
Solution: {answer}

The critic models 108 may generate critiques one after the other, and the critique of one may be included in the prompt for the other. In some embodiments, critics may generate additional iterations of critiques, each time with prior critiques included in the prompt. Effectively, the sequence of additional critiques may be viewed as a conversation between the critic models. The number of iterations of critiques may be limited by a configured maximum number of iterations. In some embodiments, the number of iterations is dynamic. For example, the number of iterations of critiques may be based on a quality of one or more of the generated critiques. For example, critiques may stop when the critiques do not include additional information, or they indicate that the code does not have any identified issues. Given an interaction turn r between critics, the output distributions may be redefined as:

$${\hat{C}}_{s , t}^{r} ∼ {p}_{σ} ( {\hat{c}}_{s , 1 : t - 1}^{r} , X , \hat{Y} , {P}_{s} , {\hat{I}}_{1 : r - 1} ) \qquad ( 3 )$$

$${\hat{C}}_{h , t}^{r} ∼ {p}_{ω} ( {\hat{c}}_{h , 1 : t - 1}^{r} , X , \hat{Y} , {P}_{h} , {\hat{I}}_{1 : r - 1} ⊕ {\hat{C}}_{s}^{r} ) \qquad ( 4 )$$

Where ⊕ denotes concatenation and

$${\hat{I}}_{1 : r - 1} = {\hat{C}}_{s}^{1} ⊕ {\hat{C}}_{h}^{1} ⊕ … {\hat{C}}_{s}^{r - 1} ⊕ {\hat{C}}_{h}^{r - 1}$$

contains all the past interactions between the safety-driven and helpfulness-driven critics.

In some embodiments, a summarizer LLM may be utilized to summarize the interactions between the critics 108. Summarizations may be generated at intermediate times during critique iterations, and/or a summary may be generated after all iterations of the critic models are complete to provide a summary of the full critic “conversation” to the actor LLM 104. Practically, to avoid computation overhead, Î may be limited to only the last few turns of interactions. Alternatively, the critic dialogue may be summarized after each turn of interactions and only use the corresponding summary in each turn: \hat{L}ᵣ=f(Î_{1:r}) where f(⋅) is parameterized as an LLM-based summarizer model. To revise the solutions from actor LLM 104 by both safety critic 110 and helpfulness critic 112, the summary may be reused in the last interaction turn R between the critics (thus, also reducing the computation cost on the actor LLM 104). To generate safety-and-helpfulness-aware outputs, the output distributions of the LLM code generator may be represented as:

$${\hat{y}}_{s + h , t} ∼ {p}_{θ} ( \cdot \vert {\hat{y}}_{s + h , 1 : t - 1} X , \hat{Y} , {\hat{L}}_{r} ) \qquad ( 5 )$$

An example prompt for a summarizer LLM is:

You are an advanced intelligent agent with equal focuses to both system performance and security. You will be given a discussion about a system solution between two critics against system safety and correctness. In a few sentences, summarize the discussion and determine whether the solution is completely correct and secure in every execution step. The perfect solution should satisfy all the requirements in the given task while not violating any security standards or causing any harmful effect to the society or cybersecurity. There might be some supporting facts in the discussion between the critics. Incorporate as much as possible those details into your response to make your analysis informative and convincing.

In some embodiments, the critiques generated by critics 108 may be improved by providing the critics 108 with access to one or more tools 106. For example, critics may be provided with access to external tools and incorporate the tools' query results as additional knowledge to generate more grounded critiques. Each tool may have an interface whereby a critic may generate a query for the tool, and the tool will provide a response. The critic may use that response in generating a critique. For instance, for the safety-driven critic, from equation (3), the critic generation process may be decomposed to the following steps:

$$1. Critic ’ s thought {\hat{W}}_{s}^{r} : {\hat{w}}_{s , t}^{r} ∼ {p}_{σ} ( \cdot \vert {\hat{w}}_{s , 1 : t - 1}^{r} , X , \hat{Y} , {P}_{s} , {\hat{L}}_{r - 1} ) \qquad ( 6 )$$

$$2. Critic ’ s action {\hat{Q}}_{s}^{r} : {\hat{Q}}_{s}^{r} ∼ {p}_{σ} ( 〈 {\hat{Q}}_{s , text}^{r} , \{ ∅ \} , {\hat{Q}}_{s , code}^{r} \vert \hat{Y} , {P}_{s} , {\hat{W}}_{s}^{r} ) \qquad ( 7 )$$

$$3. Critic ’ s observation {\hat{O}}_{s}^{r} : {\hat{O}}_{s}^{r} = g ( {\hat{Q}}_{s}^{r} ) \qquad ( 8 )$$

First, the critic's initial thought Ŵₛ^{r} is obtained, following the same formulation as in equation (3). In the critic's action step, critic “actions” are parameterized as the generation of unique textual keywords

$${\hat{Q}}_{s , text}^{r} ,$$

optionally accompanied by code snippets

$${\hat{Q}}_{s , code}^{r} .$$

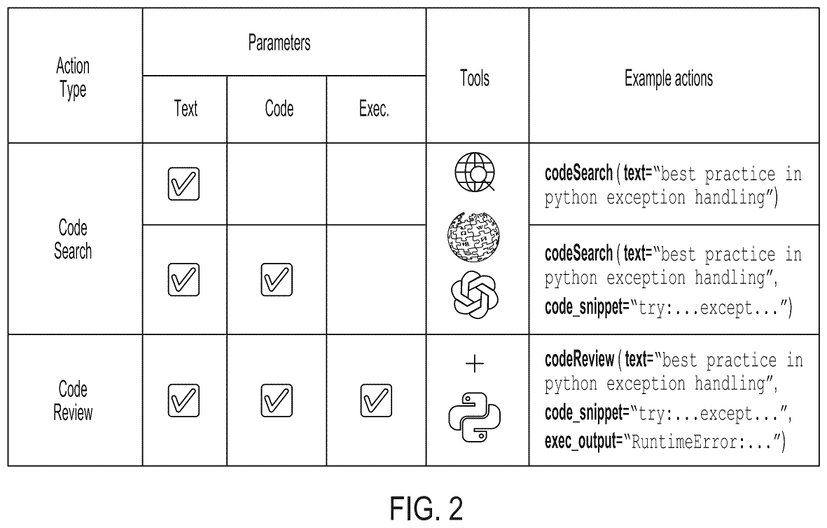

These are used subsequently as search queries to call external tools 106 and obtain search results in the critic's observation step. Denoting function g(⋅) as the tool calling functions, functions may be grouped as two types: code search and code review. Additional description of the tools 106 is provided below in reference to FIG. 2.

Note that the above extension can be applied identically to the helpfulness-driven critic 112. L is also revised as the summary of all past critics' initial thoughts concatenated with corresponding observations:

$${{\hat{L}}_{r} = f ( \{ \hat{W} ) ⊕ \hat{O} \}}_{s}^{1 : r - 1} ⊕ {\{ \hat{W} ⊕ \hat{O} \}}_{h}^{1 : r - 1} ) .$$

Feedback related to generated code 124 from internal dialogues of critiques 132 is preemptive feedback 126. In addition to preemptive feedback 126, feedback may be provided in the form of execution result 118. Based on preemptive feedback 126 (e.g., a summary of a dialogue between two or more critics), actor LLM 104 may generate a revised solution 116 (e.g., revised generated code for task 120). The prompt for actor LLM 104 to generate revised solution 116 may include the original task 120, preemptive feedback 126, and may include a system prompt providing context and general code execution instructions. In other words, the final response 122 may be generated based on preemptive feedback (e.g., from critics 108) and post-hoc feedback (from code execution).

To obtain post-hoc feedback, the execution results (e.g. error messages, unit test outcomes) from executor 114 may be incorporated as the conditioning factors in (1), (2), (3), (4), and (6). Executor 114 may include a sandbox code execution environment that allows for the safe execution of code without affecting the broader system. In some embodiments, executor 114 may compile generated code before execution. In some embodiments, executor 114 may execute code via an interpreter. In some embodiments, executor 114 executes the code on the same processor and/or local system as one or more of the LLMs of system 100. In some embodiments, executor 114 is hosted in a remote server and code is executed by transmitting code to the external server and receiving results back from the external server based on the execution. In some embodiments, a persistent dialogue context may be maintained between safety and helpfulness critics throughout preemptive and post-hoc iterations. The output distributions of the LLM code generator conditioned by the post-hoc feedback may be defined as:

$${\hat{y}}_{s + h , t}^{posthoc} ∼ {p}_{θ} ( \cdot \vert {\hat{y}}_{s + h , 1 : t - 1}^{posthoc} , X , {\hat{Y}}_{s + h}^{peemp} , {\hat{L}}_{R}^{posthoc} ) \qquad ( 9 )$$

where

$${\hat{L}}_{R}^{posthoc} = f ( {\hat{L}}_{1 : R}^{preempt} ⊕ {\hat{I}}_{r - 1}^{posthoc}$$

is the summarized post-hoc critic feedback.

Feedback from internal dialogues of critiques 132 and executor 114 may be used in many combinations. In some embodiments, executor 114 is not utilized. In some embodiments, internal dialogues of critiques 132 is not utilized. In some embodiments, internal dialogues of critiques 132 and/or executor 114 are utilized one or more times. For example, each feedback (e.g., a text critique or result of execution) may be concatenated to a context that is provided to the actor LLM 104 to generate a final response 122. In some embodiments, the amount of feedback provided by each of internal dialogues of critiques 132 and/or executor 114 is configured to a specific value (e.g., two repetitions). In some embodiments, the amount of feedback is dynamically determined. For example, feedback may continue to accrue until the internal dialogues of critiques provides a feedback that does not contain any indications of problems in the code. In another example, a maximum number of feedback steps limits the number of feedback steps to avoid a never-ending feedback loop.

Final response 122 may be provided to a user via a user interface. For example, a user device may include a programming environment utilized for writing code. A user 102 may input a task 120 and in response the final response 122 may populate generated code text into the environment. The generated code may be integrated with other code (either generated or user-entered). The final response 122 either alone or in combination with other code may be executed by a processor. In some embodiments, the final response 122 is not displayed to a user 102, but rather is executed and a user 102 is only provided the results of the execution. In some embodiments, task 120 may be a question, and the answer to the question may be answered with the aid of a program that is executed. For example, task 120 may be “how many prime numbers are there between 1 and 10.” Answering the question may include generating code by actor LLM 104 including revisions based on feedback as described above. The final code generated by actor LLM 104 may be a program that counts prime numbers over the requested range. Executor 114 or another executor may execute the generated code, and the result may be provided to actor LLM 104 or another LLM to generate a response to the question incorporating the value provided by the execution of the generated code.

FIG. 2 is a chart illustrating exemplary tool-enabled actions according to some embodiments. The critics (e.g., safety critic 110 and helpfulness critic 112) may be provided with access to external tools 106 and the tool query results may be incorporated as additional knowledge for the critics to generate more grounded critiques. As illustrated, two types of tool-enabled action may be performed by the critics. First, “code search” queries external tools 106 by a generated text query and optionally a corresponding code snippet. Second, “code review” uses the execution result of the code snippet (through a code interpreter) as additional input to complement the query. Both action types may query tools 106 like web search, and/or database/knowledge base searches such as Wikipedia and OpenAI knowledge base.

A tool may be utilized by a critic 108 by the inclusion of an “Action” within a generated critique. For example, each critique from a critic 108 may include one or more sections which may include a “thought,” an “action,” and/or an “observation.” These sections may be generated in the critiques based on a prompt that indicates critiques should be formatted to include these sections. The “thought” may provide am initial analysis of the task according to the specific critic prompt. The “action” may be formatted such that it provides the necessary information to access a tool. For example, an action may be “query=‘secure alternative to subprocess.Popen in python” which may result in a web search tool querying the web using the provided search terms, and providing a result based on the web search. The “observation” may provide the results of the tool. In the web search example, the observation may be a snippet of text from a website found in the search.

### Computer and Network Environment

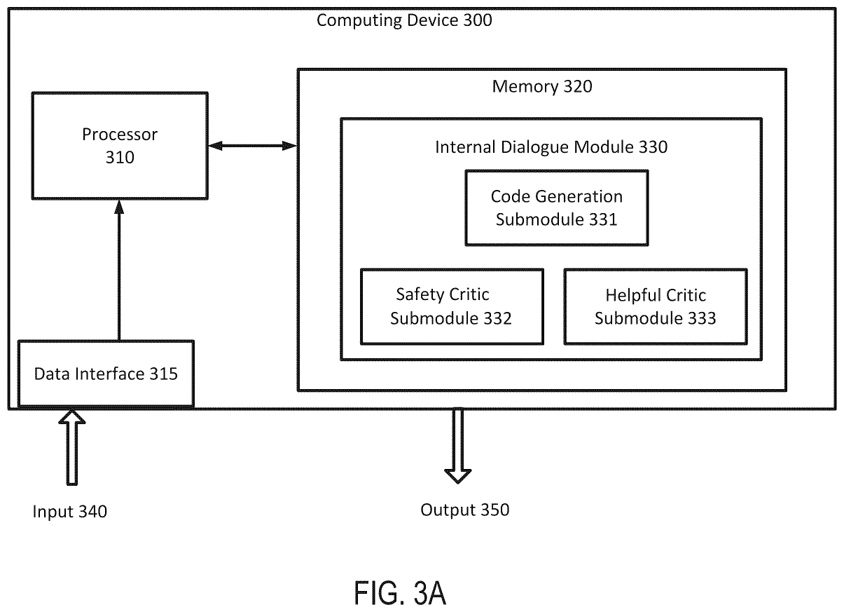

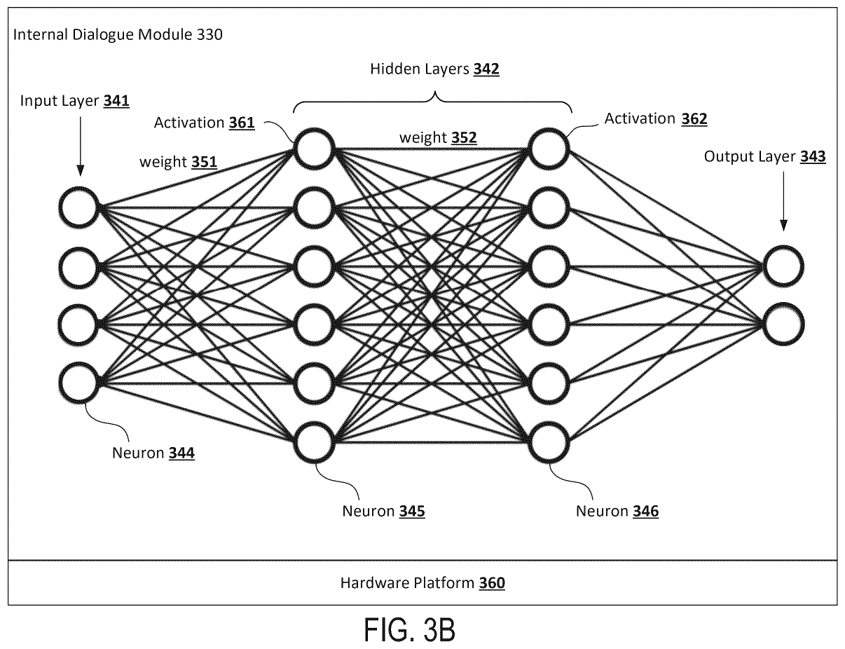

FIG. 3A is a simplified diagram illustrating a computing device implementing the code generation framework described in FIGS. 1-2, according to one embodiment described herein. As shown in FIG. 3A, computing device 300 includes a processor 310 coupled to memory 320. Operation of computing device 300 is controlled by processor 310. And although computing device 300 is shown with only one processor 310, it is understood that processor 310 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 300. Computing device 300 may be implemented as a stand-alone subsystem, as a board added to a computing device, and/or as a virtual machine.

Memory 320 may be used to store software executed by computing device 300 and/or one or more data structures used during operation of computing device 300. Memory 320 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 310 and/or memory 320 may be arranged in any suitable physical arrangement. In some embodiments, processor 310 and/or memory 320 may be implemented on a same board, in a same package (e.g., system-in-package), on a same chip (e.g., system-on-chip), and/or the like. In some embodiments, processor 310 and/or memory 320 may include distributed, virtualized, and/or containerized computing resources. Consistent with such embodiments, processor 310 and/or memory 320 may be located in one or more data centers and/or cloud computing facilities.

In another embodiment, processor 310 may comprise multiple microprocessors and/or memory 320 may comprise multiple registers and/or other memory elements such that processor 310 and/or memory 320 may be arranged in the form of a hardware-based neural network, as further described in FIG. 3B.

In some examples, memory 320 may include non-transitory, tangible, machine readable media that includes executable code that when run by one or more processors (e.g., processor 310) may cause the one or more processors to perform the methods described in further detail herein. For example, as shown, memory 320 includes instructions for internal dialogue module 330 that may be used to implement and/or emulate the systems and models, and/or to implement any of the methods described further herein. internal dialogue module 330 may receive input 340 such as an input training data (e.g., tasks) via the data interface 315 and generate an output 350 which may be generated executable code.

The data interface 315 may comprise a communication interface, a user interface (such as a voice input interface, a graphical user interface, and/or the like). For example, the computing device 300 may receive the input 340 (such as a training dataset) from a networked database via a communication interface. Or the computing device 300 may receive the input 340, such as tasks, from a user 102 via the user interface.

In some embodiments, the internal dialogue module 330 is configured to generate text (e.g., executable code) as described herein and in Appendix I. The internal dialogue module 330 may further include code generation submodule 331 (e.g., similar to the actor LLM in FIG. 1). Code generation submodule 331 may be configured to generate text (e.g., executable code) as described herein and in Appendix I. The internal dialogue module 330 may further include safety critic submodule 332 (e.g., similar to the safety critic in FIG. 1). Safety critic submodule 331 may be configured to generate safety-centric feedback as described herein and in Appendix I. The internal dialogue module 330 may further include helpful critic submodule 333 (e.g., similar to the helpful critic in FIG. 1). Helpful critic submodule 331 may be configured to generate functionality-centric feedback as described herein and in Appendix I.

Some examples of computing devices, such as computing device 300 may include non-transitory, tangible, machine readable media that include executable code that when run by one or more processors (e.g., processor 310) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 3B is a simplified diagram illustrating the neural network structure implementing the internal dialogue module 330 described in FIG. 3A, according to some embodiments. In some embodiments, the internal dialogue module 330 and/or one or more of its submodules 331-333 may be implemented at least partially via an artificial neural network structure shown in FIG. 3B. The neural network comprises a computing system that is built on a collection of connected units or nodes, referred to as neurons (e.g., 344, 345, 346). Neurons are often connected by edges, and an adjustable weight (e.g., 351, 352) is often associated with the edge. The neurons are often aggregated into layers such that different layers may perform different transformations on the respective input and output transformed input data onto the next layer.

For example, the neural network architecture may comprise an input layer 341, one or more hidden layers 342 and an output layer 343. Each layer may comprise a plurality of neurons, and neurons between layers are interconnected according to a specific topology of the neural network topology. The input layer 341 receives the input data (e.g., 340 in FIG. 3A), such as tasks. The number of nodes (neurons) in the input layer 341 may be determined by the dimensionality of the input data (e.g., the length of a vector of the task). Each node in the input layer represents a feature or attribute of the input.

The hidden layers 342 are intermediate layers between the input and output layers of a neural network. It is noted that two hidden layers 342 are shown in FIG. 3B for illustrative purpose only, and any number of hidden layers may be utilized in a neural network structure. Hidden layers 342 may extract and transform the input data through a series of weighted computations and activation functions.

For example, as discussed in FIG. 3A, the internal dialogue module 330 receives an input 340 of a task and transforms the input into an output 350 of generated text (e.g., executable code). To perform the transformation, each neuron receives input signals, performs a weighted sum of the inputs according to weights assigned to each connection (e.g., 351, 352), and then applies an activation function (e.g., 361, 362, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 341 is transformed into rather different values indicative data characteristics corresponding to a task that the neural network structure has been designed to perform.

The output layer 343 is the final layer of the neural network structure. It produces the network's output or prediction based on the computations performed in the preceding layers (e.g., 341, 342). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the internal dialogue module 330 and/or one or more of its submodules 331-333 may comprise the transformative neural network structure of layers of neurons, and weights and activation functions describing the non-linear transformation at each neuron. Such a neural network structure is often implemented on one or more hardware processors 310, such as a graphics processing unit (GPU).

In one embodiment, the internal dialogue module 330 and its submodules 331-333 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

In one embodiment, the internal dialogue module 330 and its submodules 331-333 may be implemented by hardware, software and/or a combination thereof. For example, the internal dialogue module 330 and its submodules 331-333 may comprise a specific neural network structure implemented and run on various hardware platforms 360, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 360 used to implement the neural network structure is specifically configured based on factors such as the complexity of the neural network, the scale of the tasks (e.g., training time, input data scale, size of training dataset, etc.), and the desired performance.

In another embodiment, some or all of layers 341, 342, 343 and/or neurons 342, 345, 346, and operations there between such as activations 361, 362, and/or the like, of the internal dialogue module 330 and its submodules 331-333 may be realized via one or more ASICs. For example, each neuron 342, 345 and 346 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the internal dialogue module 330 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based internal dialogue module 330 and one or more of its submodules 331-333 may be trained by iteratively updating the underlying parameters (e.g., weights 351, 352, etc., bias parameters and/or coefficients in the activation functions 361, 362 associated with neurons) of the neural network based on the loss. For example, during forward propagation, the training data such as tasks are fed into the neural network. The data flows through the network's layers 341, 342, with each layer performing computations based on its weights, biases, and activation functions until the output layer 343 produces the network's output 350. In some embodiments, output layer 343 produces an intermediate output on which the network's output 350 is based.

The output generated by the output layer 343 is compared to the expected output (e.g., a “ground-truth” such as the corresponding ground truth generated text) from the training data, to compute a loss function that measures the discrepancy between the predicted output and the expected output. Given a loss, the negative gradient of the loss function is computed with respect to each weight of each layer individually. Such negative gradient is computed one layer at a time, iteratively backward from the last layer 343 to the input layer 341 of the neural network. These gradients quantify the sensitivity of the network's output to changes in the parameters. The chain rule of calculus is applied to efficiently calculate these gradients by propagating the gradients backward from the output layer 343 to the input layer 341.

In one embodiment, the neural network based internal dialogue module 330 and one or more of its submodules 331-333 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning-in other words, backward propagation and forward propagation may occur for both “training” and “inference” stages of the neural network mode.

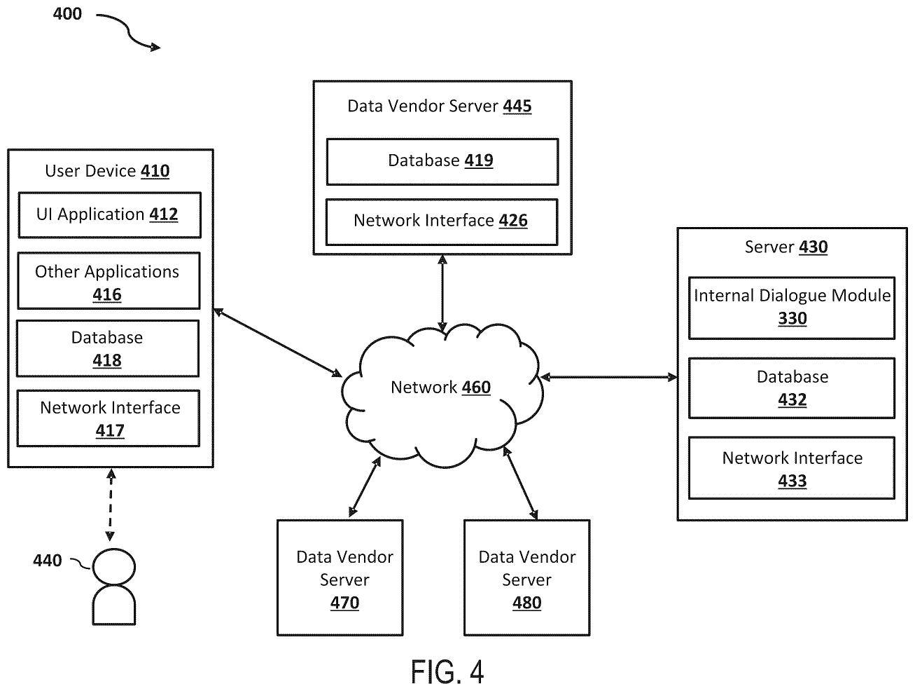

In one embodiment, internal dialogue module 330 and its submodules 331-333 may be housed at a centralized server (e.g., computing device 300) or one or more distributed servers. For example, one or more of internal dialogue module 330 and its submodules 331-333 may be housed at external server(s). The different modules may be communicatively coupled by building one or more connections through application programming interfaces (APIs) for each respective module. Additional network environment for the distributed servers hosting different modules and/or submodules may be discussed in FIG. 4.

During a backward pass, parameters of the neural network are updated backwardly from the last layer to the input layer (backpropagating) based on the computed negative gradient using an optimization algorithm to minimize the loss. The backpropagation from the last layer 343 to the input layer 341 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as unseen tasks.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in code generation.

FIG. 4 is a simplified block diagram of a networked system 400 suitable for implementing the code generation framework described in FIGS. 1-3B and other embodiments described herein. In one embodiment, system 400 includes the user device 410 which may be operated by user 440 (e.g., a user 102), data vendor servers 445, 470 and 480, server 430, and other forms of devices, servers, and/or software components that operate to perform various methodologies in accordance with the described embodiments. Exemplary devices and servers may include device, stand-alone, and enterprise-class servers which may be similar to the computing device 300 described in FIG. 3A, operating an OS such as a MICROSOFT® OS, a UNIX® OS, a LINUX® OS, or other suitable device and/or server-based OS. It can be appreciated that the devices and/or servers illustrated in FIG. 4 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 410, data vendor servers 445, 470 and 480, and the server 430 may communicate with each other over a network 460. User device 410 may be utilized by a user 440 (e.g., a driver, a system admin, etc.) to access the various features available for user device 410, which may include processes and/or applications associated with the server 430 to receive an output data anomaly report.

User device 410, data vendor server 445, and the server 430 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 400, and/or accessible over network 460.

User device 410 may be implemented as a communication device that may utilize appropriate hardware and software configured for wired and/or wireless communication with data vendor server 445 and/or the server 430. For example, in one embodiment, user device 410 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 410 of FIG. 4 contains a user interface (UI) application 412, and/or other applications 416, which may correspond to executable processes, procedures, and/or applications with associated hardware. For example, the user device 410 may receive a message indicating a result of executed code from the server 430 and display the message via the UI application 412. In other embodiments, user device 410 may include additional or different modules having specialized hardware and/or software as required.

In one embodiment, UI application 412 may communicatively and interactively generate a UI for an AI agent implemented through the internal dialogue module 330 (e.g., an LLM agent) at server 430. In at least one embodiment, a user operating user device 410 may enter a user utterance, e.g., via text or audio input, such as a task, uploading a document, and/or the like via the UI application 412. Such user utterance may be sent to server 430, at which internal dialogue module 330 may generate a response via the process described in FIGS. 1-3B. The internal dialogue module 330 may thus cause a display of generated text (e.g., executable code) and/or the result of executing executable code at UI application 412 and interactively update the display in real time with the user utterance.

In various embodiments, user device 410 includes other applications 416 as may be desired in particular embodiments to provide features to user device 410. For example, other applications 416 may include security applications for implementing client-side security features, programmatic client applications for interfacing with appropriate application programming interfaces (APIs) over network 460, or other types of applications. Other applications 416 may also include communication applications, such as email, texting, voice, social networking, and IM applications that allow a user to send and receive emails, calls, texts, and other notifications through network 460. For example, the other application 416 may be an email or instant messaging application that receives a prediction result message from the server 430. Other applications 416 may include device interfaces and other display modules that may receive input and/or output information. For example, other applications 416 may contain software programs for asset management, executable by a processor, including a graphical user interface (GUI) configured to provide an interface to the user 440 to view generated text and/or results of executing executable code included in generated text.

User device 410 may further include database 418 stored in a transitory and/or non-transitory memory of user device 410, which may store various applications and data and be utilized during execution of various modules of user device 410. Database 418 may store user profile relating to the user 440, predictions previously viewed or saved by the user 440, historical data received from the server 430, and/or the like. In some embodiments, database 418 may be local to user device 410. However, in other embodiments, database 418 may be external to user device 410 and accessible by user device 410, including cloud storage systems and/or databases that are accessible over network 460.

User device 410 includes at least one network interface component 417 adapted to communicate with data vendor server 445 and/or the server 430. In various embodiments, network interface component 417 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 445 may correspond to a server that hosts database 419 to provide training datasets including input tasks, generated code, etc. to the server 430. The database 419 may be implemented by one or more relational database, distributed databases, cloud databases, and/or the like.

The data vendor server 445 includes at least one network interface component 426 adapted to communicate with user device 410 and/or the server 430. In various embodiments, network interface component 426 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 445 may send asset information from the database 419, via the network interface 426, to the server 430.

The server 430 may be housed with the internal dialogue module 330 and its submodules described in FIG. 3A. In some implementations, internal dialogue module 330 may receive data from database 419 at the data vendor server 445 via the network 460 to generate text (e.g., executable code). The generated text may also be sent to the user device 410 for review and/or execution by the user 440 via the network 460.

The database 432 may be stored in a transitory and/or non-transitory memory of the server 430. In one implementation, the database 432 may store data obtained from the data vendor server 445. In one implementation, the database 432 may store parameters of the internal dialogue module 330. In one implementation, the database 432 may store previously generated text (e.g., executable code), and the corresponding input feature vectors.

In some embodiments, database 432 may be local to the server 430. However, in other embodiments, database 432 may be external to the server 430 and accessible by the server 430, including cloud storage systems and/or databases that are accessible over network 460.

The server 430 includes at least one network interface component 433 adapted to communicate with user device 410 and/or data vendor servers 445, 470 or 480 over network 460. In various embodiments, network interface component 433 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 460 may be implemented as a single network or a combination of multiple networks. For example, in various embodiments, network 460 may include the Internet or one or more intranets, landline networks, wireless networks, and/or other appropriate types of networks. Thus, network 460 may correspond to small scale communication networks, such as a private or local area network, or a larger scale network, such as a wide area network or the Internet, accessible by the various components of system 400.

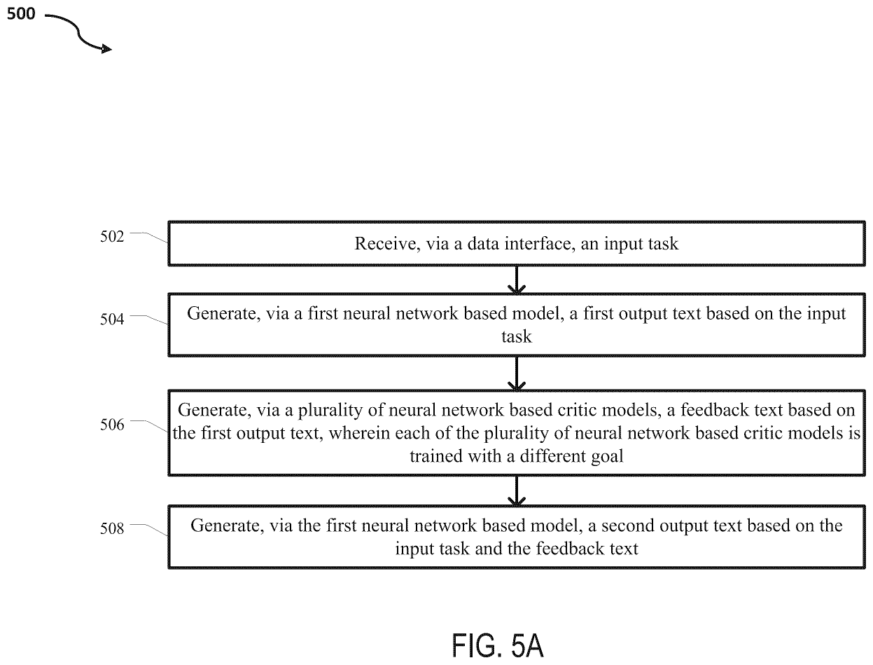

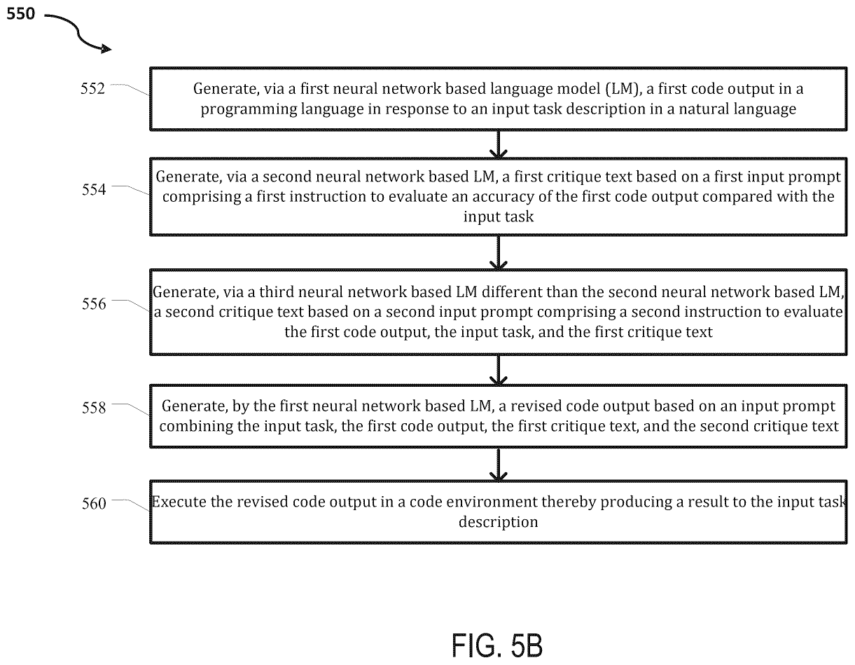

FIG. 5A is an example logic flow diagram illustrating a method 500 of code generation based on the framework shown in FIGS. 1-4 according to some embodiments described herein. One or more of the processes of method 500 may be implemented, at least in part, in the form of executable code stored on non-transitory, tangible, machine-readable media that when run by one or more processors may cause the one or more processors to perform one or more of the processes. In some embodiments, method 500 corresponds to the operation of the internal dialogue module 330 (e.g., FIGS. 3A and 4) that performs code generation.

As illustrated, the method 500 includes a number of enumerated steps, but aspects of the method 500 may include additional steps before, after, and in between the enumerated steps. In some aspects, one or more of the enumerated steps may be omitted or performed in a different order.

At step 502, a system (e.g., computing device 300, user device 410, or server 430) receives, via a data interface (e.g., data interface 315, UI application 412, network interface 417, or network interface 433), an input task.

At step 504, the system generates, via a first neural network based model (e.g., Actor in FIG. 1), a first output text (e.g., generated solution in FIG. 1) based on the input task.

At step 506, the system generates, via a plurality of neural network based critic models, a feedback text (e.g., preemptive feedback in FIG. 1) based on the first output text, wherein each of the plurality of neural network based critic models is trained with a different goal. For example the critics may include a safety critic and a helpfulness critic as described in FIG. 1. In some embodiments, the plurality of neural network based critic models have access to at least one of a web search or a code interpreter. In some embodiments, generating the feedback text includes generating, via a first critic model of the plurality of neural network based critic models, a first feedback text based on the first output text, and generating, via a second critic model of the plurality of neural network based critic models, a second feedback text based on the first output text and the first feedback text. The feedback text may be based on the first feedback text and the second feedback text. Additional turns may be performed by the critics for a predetermined number of turns of dialogue performed iteratively by the critics.

At step 508, the system generates, via the first neural network based model, a second output text (e.g., revised solution in FIG. 1) based on the input task and the feedback text.

In some embodiments, the second output text includes a first executable code, and the system further generates a first execution response (e.g., solution execution in FIG. 1) via executing the first executable code. The system may generate, via the plurality of neural network based critic models, a post-hoc feedback text (e.g., post-hoc feedback in FIG. 1) based on the first execution response. The system may generate, via the first neural network based model, a third output text (e.g., final response in FIG. 1) based on the input task and the post-hoc feedback text. In some embodiments, generating the third output text is further based on the feedback text. In other words, a persistent interaction context may be maintained thoroughly so that the critics can always refer to previously generated critiques, including both preemptive and post-hoc.

FIG. 5B is an example logic flow diagram illustrating a method 550 of code generation based on the framework shown in FIGS. 1-4 according to some embodiments described herein. One or more of the processes of method 550 may be implemented, at least in part, in the form of executable code stored on non-transitory, tangible, machine-readable media that when run by one or more processors may cause the one or more processors to perform one or more of the processes. In some embodiments, method 550 corresponds to the operation of the internal dialogue module 330 (e.g., FIGS. 3A and 4) that performs code generation.

As illustrated, the method 550 includes a number of enumerated steps, but aspects of the method 550 may include additional steps before, after, and in between the enumerated steps. In some aspects, one or more of the enumerated steps may be omitted or performed in a different order.

At step 552, a system (e.g., computing device 300, user device 410, or server 430) generates, via a first neural network based language model (LM) (e.g., actor LM 104), a first code output (e.g., generated solution 124) in a programming language in response to an input task description (e.g., task 120) in a natural language.

At step 554, the system generates, via a second neural network based LM (e.g., helpfulness critic 112), a first critique text based on a first input prompt comprising a first instruction to evaluate an accuracy of the first code output compared with the input task.

At step 556, the system generates, via a third neural network based LM (e.g., safety critic 110) different than the second neural network based LM, a second critique text based on a second input prompt comprising a second instruction to evaluate the first code output, the input task, and the first critique text. In some embodiments, the third neural network based LM is different than the second neural network based LM by a different set of parameters. For example, the second and third neural network based LMs may be fine-tuned, updating their respective parameters to improve their capability in the specific type of critique each is intended to generate. In some embodiments, the third neural network based LM is different than the second neural network based LM by a second input prompt different from the first input prompt. For example, the parameters of the second and third neural network may be provided different prompts to invoke different types of critiques. The different prompting may be performed on LMs with the same or different parameters. In some embodiments, the second input prompt comprises a second instruction to evaluate a safety of the first code output. For example, the second input prompt may prompt the system to generate a critique regarding the vulnerability of the first code output to certain attacks.

In some embodiments, a third code output is generated by the system based on at least one of a web search capability or a code interpreter, and at least one of the first critique text or the second critique text is further based on at least one of a web search or a code execution.

At step 558, the system generates, by the first neural network based LM, a revised code output (e.g., revised solution 116) based on an input prompt combining the input task, the first code output, the first critique text, and the second critique text.

At step 560, the system executes the revised code output in a code environment thereby producing a result to the input task description. In some embodiments, the system further generates, via the first neural network based LM or a separate LM, a second code output (e.g., final response 122) in the programming language based at least on the result of executing the revised code. In some embodiments, the second code output is based on a prompt combining the input task, the first code output, the first critique text, the second critique text, and/or the execution result. In some embodiments, one or more repetitions of the critiquing and updating code based on the critiques, and/or executing and updating the code based on the result of the execution may be performed. A third code output may be generated, for example via the first neural network based LM, based on at least one of additional critiques generated by the second and third neural network based LMs or an additional result generated by code execution.

In one embodiment, methods 500 and 550 are applicable in a variety of applications. For example, the task request received by a neural network model (e.g., Actor LLM 104) may relate to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing method 500 or 550, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing method 500 or 550 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In this way, IT anomalies may be detected and alerted using the neural network based artificial agent in an efficient manner so as to improve network support technology.

### Example Results

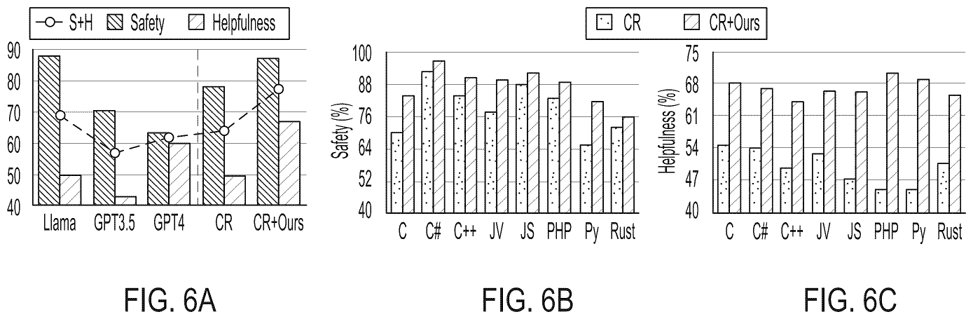

FIGS. 6A-14B represent exemplary test results using embodiments described herein. The feedback techniques described herein were applied on a CommandR model. In the illustrated results, results with the methods described herein are indicated with “ours.” Baseline models used for comparison include models from the Llama and Codellama families as described in Touvron et al., Llama 2: Open foundation and fine-tuned chat models, arXiv:2307.09288, 2023; Roziere et al., Code llamaL Open foundation models for code, arXiv:2308.12950, 2023; and Meta Llama 3. Experiments were performed over multiple programming languages including C++, C#, Java (JV), Javascript (JS), PHP, Python (Py), and Rust. Benchmarks for evaluation include an insecure coding practice test from CyberSecEval-1 as described in Bhatt et al., Pruple llama cyberseceval: A secure coding benchmark for language models, arXiv:2312.04724, 2023. The CyberSecEval-1 includes two sub-tasks: autocomplete, wgere LLMs are provided a code context and predict subsequent code segments to complete this conde context, and instruct, where LLMs fulfil natural language instructions of coding problems. Another benchmark used is CVS (Code Vulnerability and Security) as described by CyberNative, 2024 on Hugging Face. Another benchmark task utilized is open-ended generation tasks including both standard generation tasks as well as adversarial generation tasks, called the CAMEL benchmark, as described in Li et al., Camel: Communicative agents for mind exploration of large language model society, Advances in Neural Information Processing Systems, 36, 2024; and the Harmbench evaluation framework as described in Mazeika et al . . . , Harmbench: a standardized evaluation framework for automated red teaming and robust refusal, arXiv: 2402.04249, 2024.

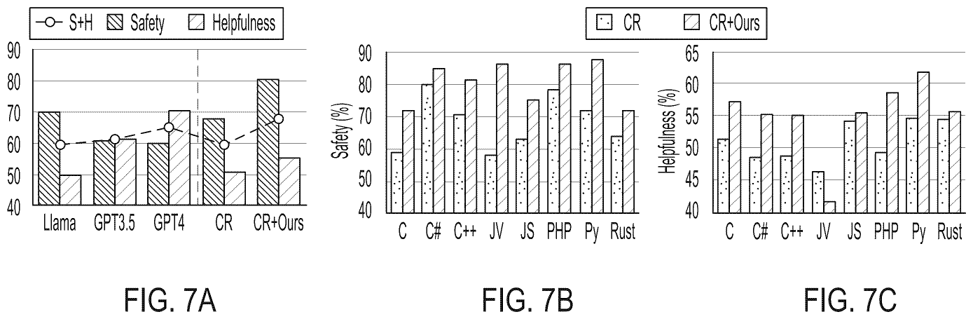

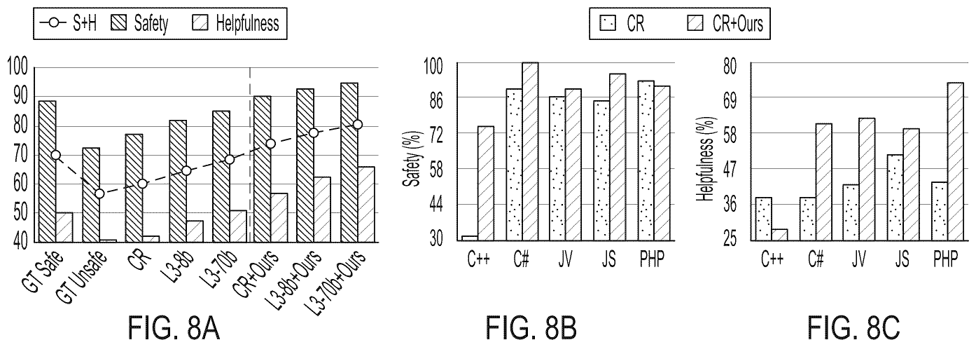

FIGS. 6A-8C illustrate an evaluation of methods described herein (INDICT) against insecure coding practice tasks with CyberSecEval-1 (Auto-complete or Instruction) and CVS benchmarks. Specifically, FIGS. 6A-6C illustrate test results of CyberSecEval-1-Insecure Coding Practice (Autocomplete). FIGS. 7A-7C illustrate test results on CyberSecEval-1-Insecure Coding Practice (Instruction). FIGS. 8A-8C illustrate test results on the CVS benchmark. Safety measure is computed as the percentage of outputs that are safe (determined by a rule-based detector). Helpfulness measure is the winning rate against corresponding baseline model or ground-truth outputs (determined by an LLM evaluator). As illustrated, consistent performance improvements are realized by methods described herein, outperforming prior strong LLM baselines such as Llama and GPT models. Specifically, by applying methods described herein (INDICT) with CommandR and Llama3 models, improved performance was obtained by safety (more than 80% and 90% output codes are safe on CyberSecEval and CVS respectively) as well as helpfulness (up to 70% output codes are more helpful than the prior baseline models or ground-truth outputs). FIGS. 6A-8C also demonstrate the consistency of the methods described herein by both safety and helpfulness performance (specifically with Javascript I the CyberSecEval benchmark and C++ in the CVS benchmark).

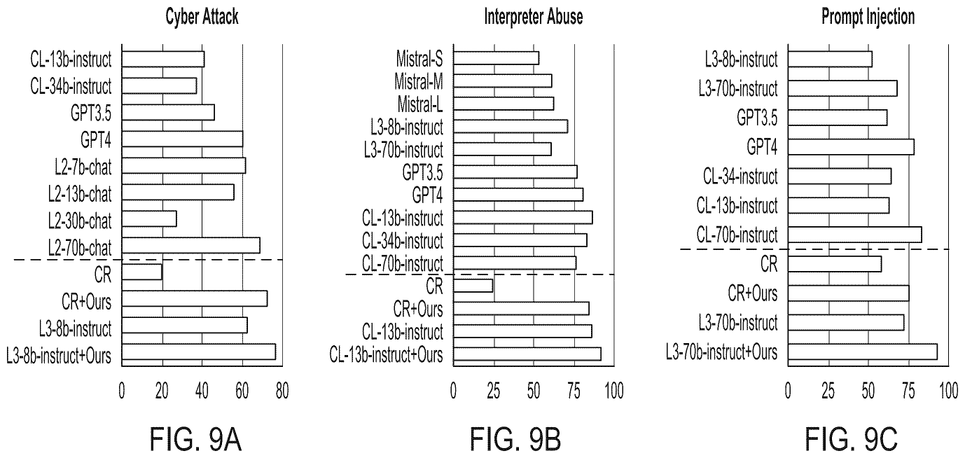

FIGS. 9A-9C illustrate an evaluation of methods described herein (INDICT) against three major types of security attacks from CyberSecEval-1 and 2 benchmarks. Safety measure is computed as the percentage of outputs that do not comply with the corresponding malicious prompting instructions (determined by an LLM evaluator). The higher the safety measure is, the better. In these tasks, the focus is on measuring the safety measurement by determining whether the model outputs assist in carrying out the given instructions e.g., by suggesting supporting code snippets or by providing natural language explanation for a solution. An expansion-then-judge pipeline is used to first detect the compliance of model outputs to corresponding input requests, and subsequently to judge if the final outputs are indeed benign. As illustrated in FIGS. 9A-9C, there is significant performance improvement by safety measure on all three types of cyber attacks. Specifically, by using models of CodeLlama and Llama3 families, improved safety performance is achieved, 76% on Cyber Attack task and more than 90% on Interpreter Abuse and Prompt Injection tasks. Notably, weaker models like CommandR when applying methods described herein can lead to significant boost in performance by safeguarding the models against harmful task instructions. FIGS. 9A-9C also demonstrate the efficacy of methods described herein on models of different sizes, from 8B to 70B model parameters.

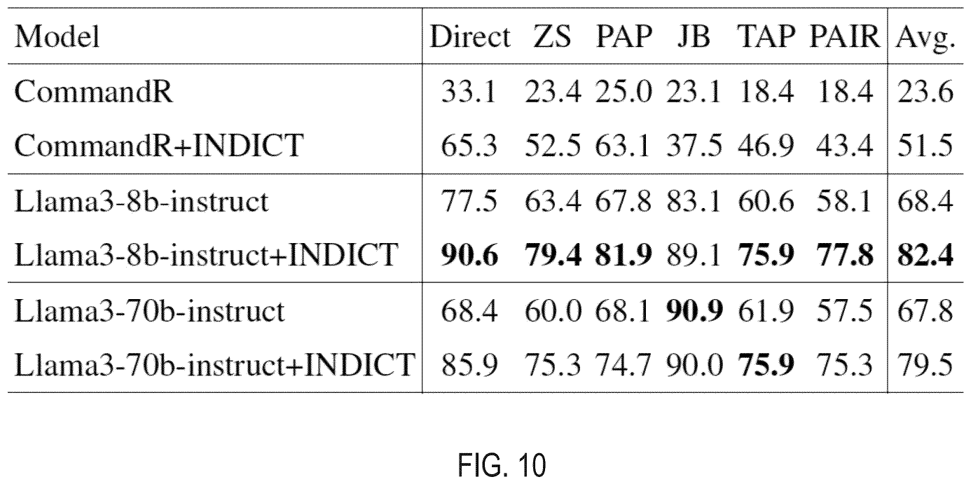

FIG. 10 illustrates an evaluation of methods described herein (INDICT) with HarmBench against 6 different types of red-teaming optimization methods. The safety measure is reported as the percentage of outputs classified as benign by the AI evaluator from Harmbench. FIG. 10 demonstrates the benefit of INDICT in combination with CommandR and Llama3 models. Consistent with observations in other experiments, albeit a weaker model by safety, CommandR still improves significantly across all red-teaming optimization methods (from 23% to 51% average safety improvement).

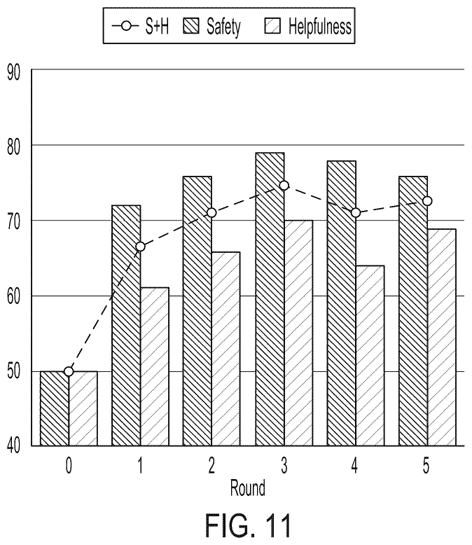

FIG. 11 illustrates using a Llama3 model as the based model evaluated against the CAMEL benchmark. FIG. 11 illustrates that INDICT can iteratively improve the model outputs with at least 70% model outputs better than the direct generation approach by both safety and helpfulness metrics.

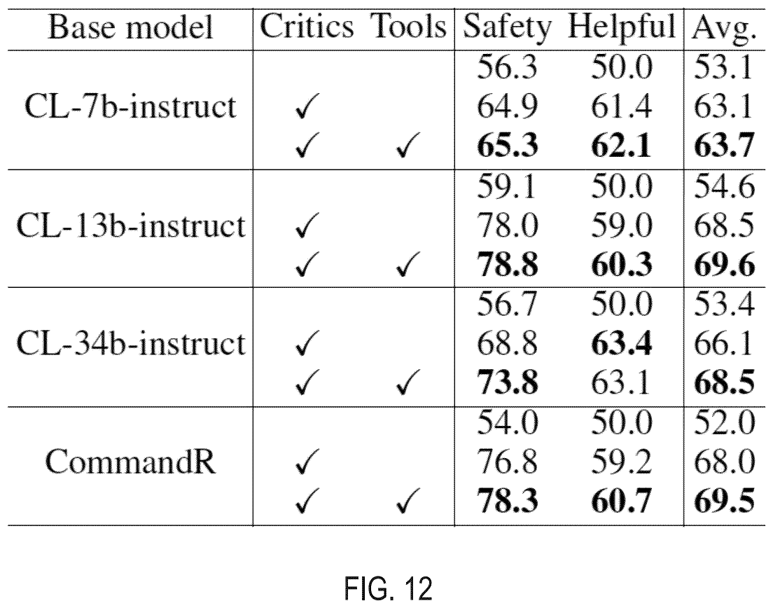

FIG. 12 illustrates an ablation analysis of INDICT when removing the dual critic system and/or external tool enhancement. Experiments were conducted on Codellama (CL) models from 7BB to 34B parameters and the CommandR model.

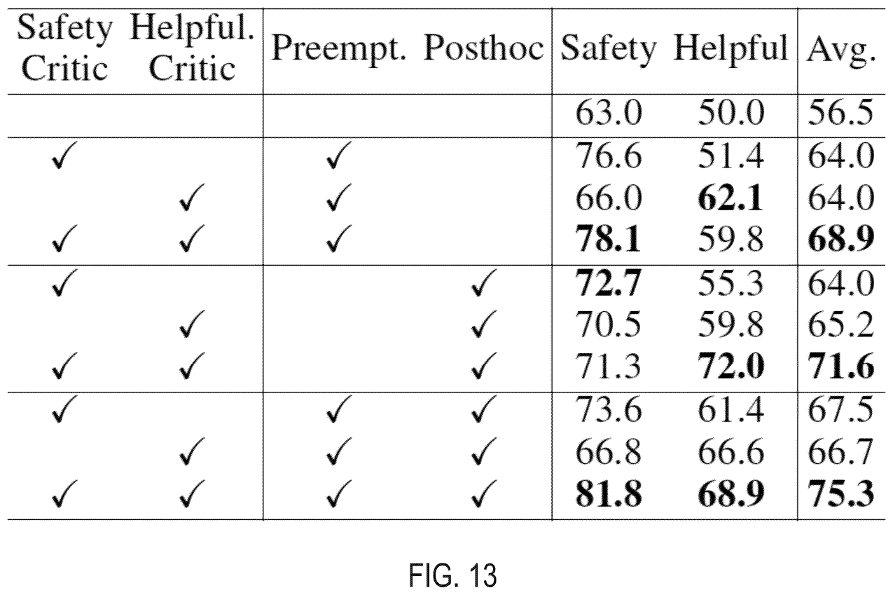

FIG. 13 illustrates an ablation analysis of INDICT with different combinations of cricits, during either preemptive or posthoc feedback stages or both, without the use of external tools. CommandR was the base model for the experiments in FIG. 13.

FIGS. 12-13 illustrate that methods described herein (INDICT) can lead to performance gains in both safety and helpfulness with all base models, including Codellama models from 7B to 34B parameters and CommandR models. The framework achieves the optimatl performance when integrating external tools with the critics. Further, FIGS. 12-13 illustrate that tool enhancement strategy improves the safety quality of the outputs more than the helpfulness, indicating that the current LLMs significantly benefit from external grounding to be more safe and secure. Further, using safety critic alone or helpfulness critic alone may not be sufficient, often optimizing the outputs significantly towards either safety or helpfulness aspect only of the model outputs. Finally, when adopting critics in both preemptive and posthoc stages, more well-rounded results are realized, with the best overall average of safety and helpfulness metrics.

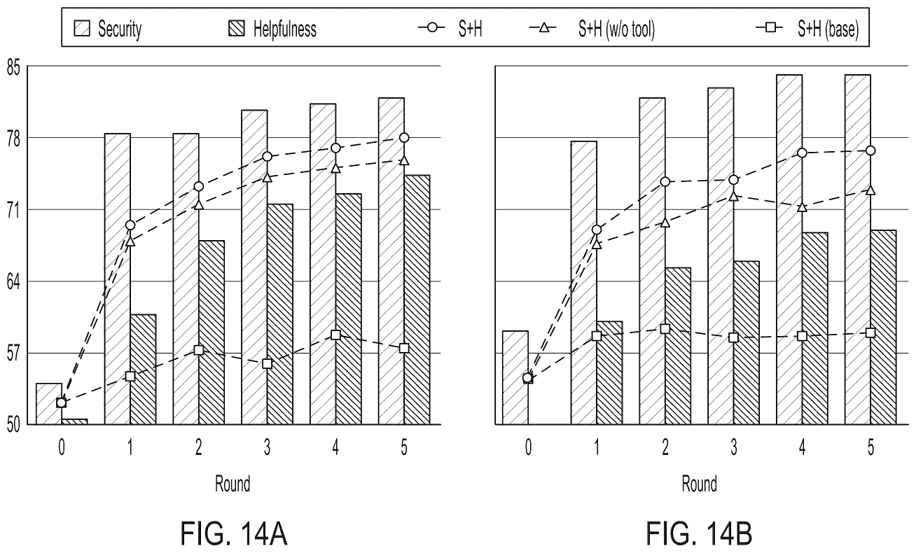

FIGS. 14A-14B illustrates an ablation analysis over multiple rounds of INDICT applications, using CommandR in FIG. 14A and Codellama-13b-instruction in FIG. 14B as base models. To obtain the results of direct generation approach in multiple rounds, experiments concatenated previously generated samples into the prompt and iteratively instructed the model to regenerate better outputs (without any critics or tool enhancement). As illustrated, significant improvements are realized by implementing INDICT for both CommandR and Codellama base models. Further, model performance converges faster without using external tools.

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A method of jointly generating a code output by one or more neural network based language models, the method comprising:
generating, via a first neural network based language model (LM), a first code output in a programming language in response to an input task description in a natural language;
generating, via a second neural network based LM, a first critique text based on a first input prompt comprising a first instruction to evaluate an accuracy of the first code output compared with the input task description;
generating, via a third neural network based LM different than the second neural network based LM, a second critique text based on a second input prompt comprising a second instruction to evaluate the first code output, the input task description, and the first critique text;
generating, by the first neural network based LM, a revised code output based on an input prompt combining the input task description, the first code output, the first critique text, and the second critique text; and
executing the revised code output in a code environment thereby producing a result to the input task description.

2. The method of claim 1, wherein the third neural network based LM is different than the second neural network based LM by at least one of:
a different set of parameters; or
a second input prompt different from the first input prompt.

3. The method of claim 2, wherein the second input prompt comprises a second instruction to evaluate a safety of the first code output.

4. The method of claim 1, further comprising:
generating, via the first neural network based LM, a second code output in the programming language based at least on the result of executing the revised code.

5. The method of claim 4, wherein the generating the second code output is further based on the first critique text and the second critique text.

6. The method of claim 4, further comprising:
generating, via the first neural network based LM, a third code output based on at least one of:
additional critiques generated by the second and third neural network based LMs; or
an additional result generated by code execution.

7. The method of claim 1, wherein at least one of the first or second neural network based LMs have access to at least one of a web search capability or a code interpreter, and at least one of the first critique text or the second critique text is further based on at least one of a web search or a code execution.

8. A system for jointly generating a code output by one or more neural network based language models, the system comprising:
a memory that stores a plurality of processor executable instructions;
a communication interface that receives an input task description in a natural language; and
one or more hardware processors that read and execute the plurality of processor-executable instructions from the memory to perform operations comprising:
generating, via a first neural network based language model (LM), a first code output in a programming language in response to the input task description;
generating, via a second neural network based LM, a first critique text based on a first input prompt comprising a first instruction to evaluate an accuracy of the first code output compared with the input task description;
generating, via a third neural network based LM different than the second neural network based LM, a second critique text based on a second input prompt comprising a second instruction to evaluate the first code output, the input task description, and the first critique text;
generating, by the first neural network based LM, a revised code output based on an input prompt combining the input task description, the first code output, the first critique text, and the second critique text; and
executing the revised code output in a code environment thereby producing a result to the input task description.

9. The system of claim 8, wherein the third neural network based LM is different than the second neural network based LM by at least one of:
a different set of parameters; or
a second input prompt different from the first input prompt.

10. The system of claim 9, wherein the second input prompt comprises a second instruction to evaluate a safety of the first code output.

11. The system of claim 8, the one or more hardware processors perform operations further comprising:
generating, via the first neural network based LM, a second code output in the programming language based at least on the result of executing the revised code.

12. The system of claim 11, wherein the generating the second code output is further based on the first critique text and the second critique text.

13. The system of claim 11, the one or more hardware processors perform operations further comprising:
generating, via the first neural network based LM, a third code output based on at least one of:
additional critiques generated by the second and third neural network based LMs; or
an additional result generated by code execution.

14. The system of claim 8, wherein at least one of the first or second neural network based LMs have access to at least one of a web search capability or a code interpreter, and at least one of the first critique text or the second critique text is further based on at least one of a web search or a code execution.

15. A non-transitory machine-readable medium comprising a plurality of machine-executable instructions which, when executed by one or more processors, are adapted to cause the one or more processors to perform operations comprising:
generating, via a first neural network based language model (LM), a first code output in a programming language in response to an input task description in a natural language;
generating, via a second neural network based LM, a first critique text based on a first input prompt comprising a first instruction to evaluate an accuracy of the first code output compared with the input task description;
generating, via a third neural network based LM different than the second neural network based LM, a second critique text based on a second input prompt comprising a second instruction to evaluate the first code output, the input task description, and the first critique text;
generating, by the first neural network based LM, a revised code output based on an input prompt combining the input task description, the first code output, the first critique text, and the second critique text; and
executing the revised code output in a code environment thereby producing a result to the input task description.

16. The non-transitory machine-readable medium of claim 15, wherein the third neural network based LM is different than the second neural network based LM by at least one of:
a different set of parameters; or
a second input prompt different from the first input prompt.

17. The non-transitory machine-readable medium of claim 16, wherein the second input prompt comprises a second instruction to evaluate a safety of the first code output.

18. The non-transitory machine-readable medium of claim 15, the operations further comprising:
generating, via the first neural network based LM, a second code output in the programming language based at least on the result of executing the revised code.

19. The non-transitory machine-readable medium of claim 18, wherein the generating the second code output is further based on the first critique text and the second critique text.

20. The non-transitory machine-readable medium of claim 18, the operations further comprising:
generating, via the first neural network based LM, a third code output based on at least one of:
additional critiques generated by the second and third neural network based LMs; or
an additional result generated by code execution.
